(19) United States
(12) Patent Application Publication
(10) Pub. No.: US 2014/0145652 A1
(43) Pub. Date: May 29, 2014

(54) MOTOR CONTROL DEVICE AND PROGRAM

(71) Applicant: AISIN SEIKI KABUSHIKI KAISHA, Kariya-shi (JP)

(72) Inventors: Hiroshi YAMAMOTO, Kariya-shi (JP); Hideyuki KANIE, Kariya-shi (JP)

(73) Assignee: AISIN SEIKI KABUSHIKI KAISHA, Kariya-shi (JP)

(21) Appl. No.: 14/091,464

(22) Filed: Nov. 27, 2013

(30) Foreign Application Priority Data
Nov. 29, 2012 (JP) 2012-260476

(51) Int. Cl. H02P 3/08

(52) U.S. Cl. CPC H02P 3/08
USPC 318/139

(57) ABSTRACT

A motor control device for controlling a motor that drives by receiving electric power supply from a power source, including: a voltage measurement unit that measures a voltage of the power source; a reduced voltage determination unit that counts a number of times the voltage becomes equal to or lower than a predetermined stop voltage; and a motor drive control unit that controls driving of the motor.

### CROSS REFERENCE TO RELATED APPLICATIONS

This application is based on and claims priority under 35 U.S.C. §119 to Japanese Patent Application No. 2012-260476 filed on Nov. 29, 2012, the entire content of which is incorporated herein by reference.

### TECHNICAL FIELD

This disclosure relates to a motor control device and particularly to a motor control device and program for controlling a motor used for equipment in an automobile.

### BACKGROUND DISCUSSION

Recently, in automobiles, a computer-controlled motor is used for equipment such as reclining seats, sliding doors, and windows. For example, a reclining seat is provided with plural motors for adjusting the position and angle of the seat bottom and the seat back. As the user presses a predetermined button, a computer controls each motor and causes the seat bottom and the seat back to be adjusted to a position and angle that are stored in advance. In such a case, the number of revolutions of the motor or the like is counted and data thereof is stored in a memory of the computer, thus realizing accurate adjustment.

In automobiles, it is often the case that electric power is supplied to a computer for control, a motor for driving equipment, a starter motor and the like from one battery via a common electric circuit. In such a case, the voltage to the computer falls due to various elements such as deterioration of the battery and driving of the motor. If a large voltage fall occurs, the resulting voltage may fall below a voltage at which normal operation of the electric circuit and of the CPU and memory of the computer can be guaranteed (referred to as a guarantee voltage). Then, an abnormality occurs in data used for control and may lead to malfunctioning. According to the technique disclosed in JP-8-63405A (Reference 1), when a voltage fall is detected, data is stored and protected in non-volatile storage means, thus preventing malfunctioning.

By the way, since a voltage fall generated by cranking at the time of engine startup or chattering of battery terminals or the like is temporary, it is desirable that the operation of the motor is temporarily stopped when the voltage fall is detected, and then the operation of the motor is automatically resumed after the voltage is recovered. For example, in the case where a voltage fall is detected and the operation of the motor is stopped during an adjustment of a reclining seat started by the user pressing a button, it is convenient if the adjustment of the reclining seat is automatically resumed after the voltage is recovered, without the user having to press the button again.

Meanwhile, as for equipment that can trap a part of a human body such as a reclining seat or sliding door, in order to improve safety, a trapping prevention function which detects deceleration of the motor when trapping happens and stops or reverses the driving of the motor is provided. However, when trapping happens, a load is applied to the motor and a voltage fall occurs. Therefore, in some cases, before the deceleration of the motor is detected, the voltage fall may be detected and the operation of the motor may be stopped. Therefore, if the operation of the motor is resumed automatically when the voltage is recovered, there is a possibility that while the trapping prevention function is left unactuated, the stopping and resuming of the motor operation may be repeated and consequently the trapping of a part of a human body may continue.

In order to prevent the continuous trapping, according to the technique disclosed in Japanese Patent No. 3889329 (Reference 2), a reference voltage for voltage fall detection is lowered when the motor is operating. Thus, when trapping happens, detection of a voltage fall before detection of the deceleration of the motor can be prevented. Therefore, even if a voltage fall occurs, the trapping prevention function can be actuated normally.

In the technique disclosed in Reference 2, the guarantee voltage of the computer and the electric circuit needs to be lowered in order to secure the amount of reduction in the reference voltage, and therefore the cost is high. Also, when the plural motors are made to operate simultaneously, the amount of reduction in the reference voltage needs to be increased accordingly. Therefore, in some cases, it is difficult to secure a sufficient amount of reduction to prevent malfunctioning.

Meanwhile, if the computer and the motor are connected to separate batteries or connected to one battery via separate electric circuits, no voltage fall occurs on the computer side when a load is applied to the motor, and therefore the problem of detecting a voltage fall before detection of trapping does not take place. However, the cost is high.

### SUMMARY

In view of the foregoing problems, it is an object of this disclosure to provide a motor control device in which continuous trapping can be prevented with a low cost when the motor stopped on a voltage fall is resumed to operate, even if the traditional trapping prevention function is not actuated.

A first aspect of this disclosure is directed to a motor control device for controlling a motor that drives by receiving electric power supply from a power source, including: a voltage measurement unit that measures a voltage of the power source; a reduced voltage determination unit that counts a number of times the voltage becomes equal to or lower than a predetermined stop voltage; and a motor drive control unit that controls driving of the motor. The motor drive control unit stops the driving of the motor if the voltage is equal to or lower than the predetermined stop voltage while the motor is driving. The motor drive control unit resumes the driving of the motor if the number of times counted by the reduced voltage determination unit is smaller than a predetermined number of times and the voltage is higher than a predetermined recovery voltage while the motor is stopped.

A second aspect of this disclosure is directed to a motor control program for controlling a motor that drives by receiving electric power supply from a power source, causing a computer to execute the steps of: measuring a voltage of the power source; counting a number of times the voltage becomes equal to or lower than a predetermined stop voltage; stopping driving of the motor if the voltage is equal to or lower than the predetermined stop voltage while the motor is driving; and resuming the driving of the motor if the number of times counted is smaller than a predetermined number of times and the voltage is higher than a predetermined recovery voltage while the motor is stopped.

The motor control device according to this disclosure can prevent a part of a human body from being trapped with a low cost when the motor stopped on a voltage fall is resumed to operate.

### BRIEF DESCRIPTION OF THE DRAWINGS

FIG. 1 is a schematic view of the configuration of a motor control system according to an embodiment of this disclosure;

FIG. 2 is a schematic view of the configuration of a motor control device according to an embodiment of this disclosure;

FIG. 3 is a functional block diagram of a motor control device according to an embodiment of this disclosure;

FIG. 4 is a flowchart of a motor control program according to an embodiment of this disclosure; and

FIG. 5 is a graph of voltage change.

### DETAILED DESCRIPTION

An embodiment of this disclosure will be described with reference to the drawings. However, the technique disclosed here is not limited to this embodiment. In the drawings described below, components having the same functions are denoted by the same reference numerals and explanation thereof may not be repeated.

### Embodiment

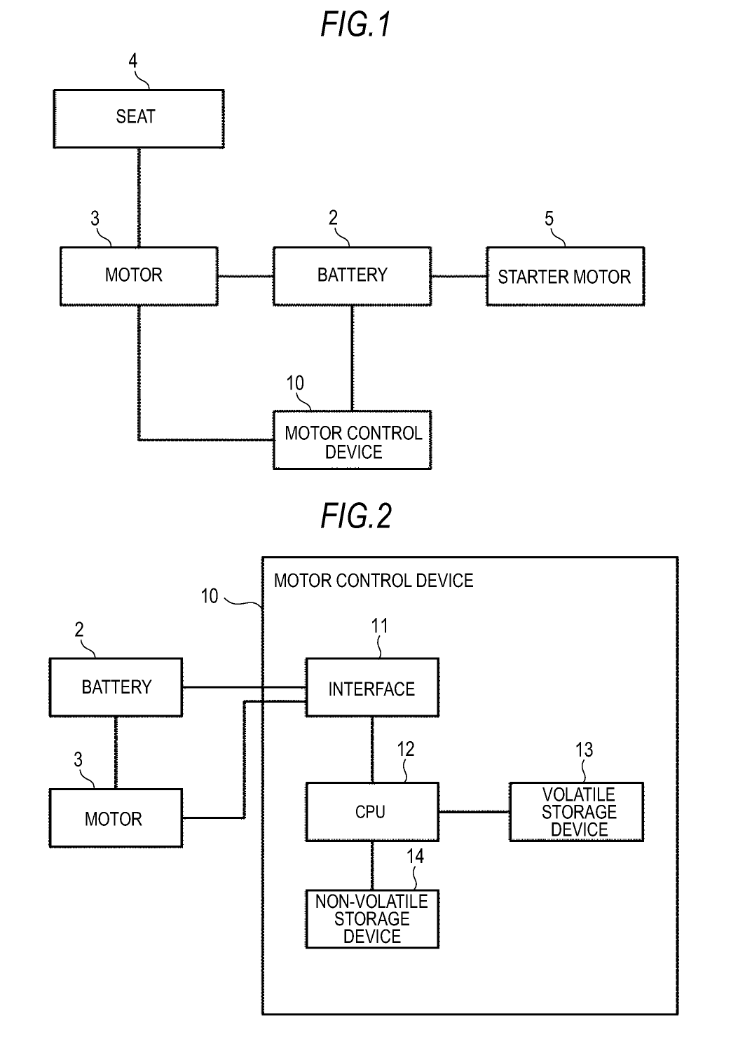

FIG. 1 is a schematic view of the configuration of a motor control system 1 according to this embodiment. The motor control system 1 is a system provided inside an automobile and includes a battery 2 as a power source for each equipment, a motor 3 that drives by receiving electric power from the battery 2, a seat 4 that is adjusted in position or the like by the driving of the motor 3, a starter motor 5 that starts up an engine by receiving electric power from the battery 2, and a motor control device 10 that controls the motor 3 by receiving electric power from the battery 2.

The battery 2 supplies electric power to each equipment in the automobile. As the battery 2, an arbitrary rechargeable battery such as a nickel-hydrogen battery or lithium-ion battery may be used. Also, a fuel battery may be used as the battery 2. The battery 2 is connected to the motor 3, the starter motor 5, and the motor control device 10, and supplies electric power to these components. The battery 2 is also connected to desired equipment in the automobile that requires electric power, such as the engine and sliding doors, other than the equipment shown in FIG. 1

The motor 3 drives by receiving supply of electric power from the battery 2 and changes the tilt of the seat back and the position of the seat bottom, of the seat 4. As the motor 3, any motor or actuator that drives with the use of electric power and operates equipment in the automobile may be used.

The target operated by the driving of the motor 3 is not limited to the seat. The motor 3 can operate arbitrary equipment in the automobile such as the windows, sunroof, sliding doors, rear door, and trunk lid.

In this embodiment, one motor 3 is connected to one seat 4. However, plural motors 3 may be connected to one seat 4. For example, a first motor 3 for changing the tilt of the seat back of the seat 4, and a second motor 3 for changing the position of the seat bottom of the seat 4 may be provided. In such a case, each of the first motor 3 and the second motor 3 is connected to the battery 2 and the motor control device 10 and controlled separately.

The starter motor 5 drives by receiving supply of electric power from the battery 2 and starts up the engine (not shown). A known configuration may be used for the starter motor 5.

The motor control device 10 is a control device that receives supply of electric power from the battery 2 and controls the driving of the motor 3. As the motor control device 10, an arbitrary computer such as a microcomputer or embedded system may be used.

In the motor control system 1, since the single battery 2 supplies electric power to each equipment, when the starter motor 5 is driven (referred to as cranking) in order to start up the engine, a voltage fall occurs in the electric power supply from the battery 2 to the motor control device 10. If a voltage fall occurs while the motor 3 is driving (particularly when plural motors 3 are driving simultaneously, the battery 2 is deteriorated, or the like), the voltage of the motor control device 10 may fall below a guarantee voltage of the motor control device 10 and the motor 3 may malfunction. Therefore, the motor control device 10 stops the driving of the motor 3 when a voltage fall occurs, and thus prevents the voltage of the motor control device 10 from falling below the guarantee voltage.

Also, there is a possibility that a part of a human body or the like may be trapped in the seat 4 due to the driving of the motor 3. Therefore, even if such trapping happens, the motor control device 10 detects the trapping and stops or reverses the motor 3, thus preventing the trapping from continuing.

FIG. 2 is a schematic view of the configuration of the motor control device 10. The motor control device 10 has an interface 11, a CPU 12, a volatile storage device 13, and a non-volatile storage device 14.

The interface 11 is connected to the battery 2 and the motor 3 via wires. The interface 11 receives supply of electric power and sends and receives signals.

The volatile storage device 13 temporarily stores control data or the like of the motor 3. The volatile storage device 13 is a device that operates at high speeds but instead needs electric power to maintain data stored therein, for example, a DRAM. The non-volatile storage device 14 stores programs and the like. The non-volatile storage device 14 is a device that does not need electric power to maintain data stored therein, for example, a hard disk drive. The non-volatile storage device 14 may also include a portable storage medium such as CD-ROM or flash memory.

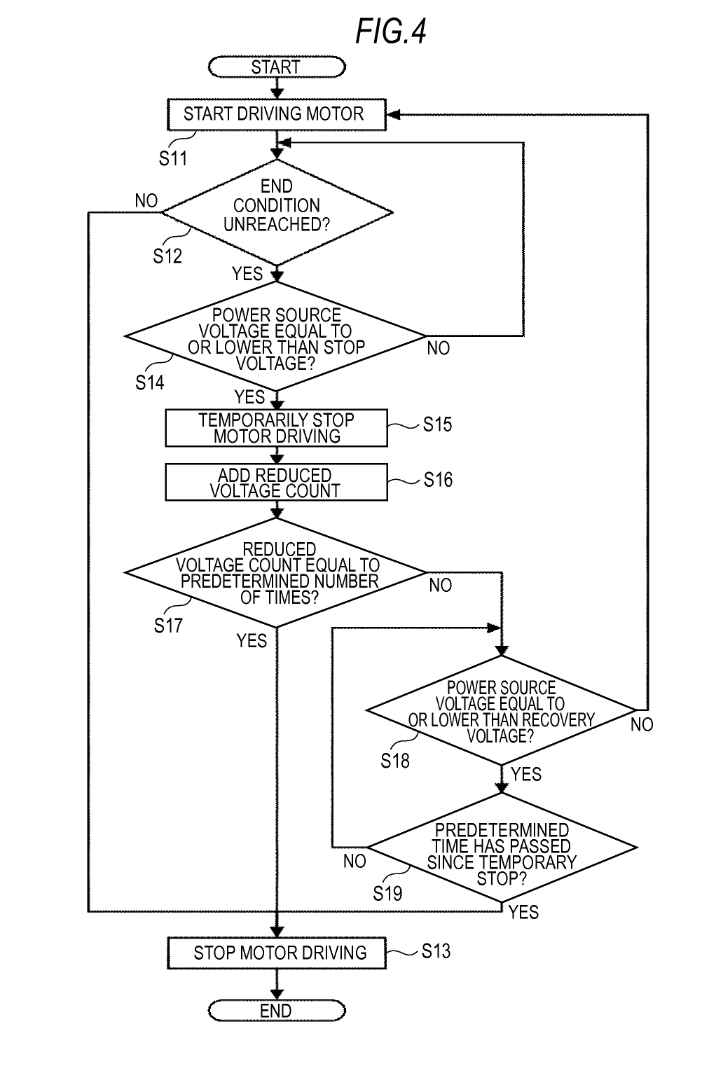

The CPU 12 stores a signal received from the interface 11 into the volatile storage device 13 as temporary data, reads out a program stored in the non-volatile storage device 14 (for example, a control program shown in FIG. 4, described later), and executes various processing operations such as calculation, control, and determination about the temporary data according to the program.

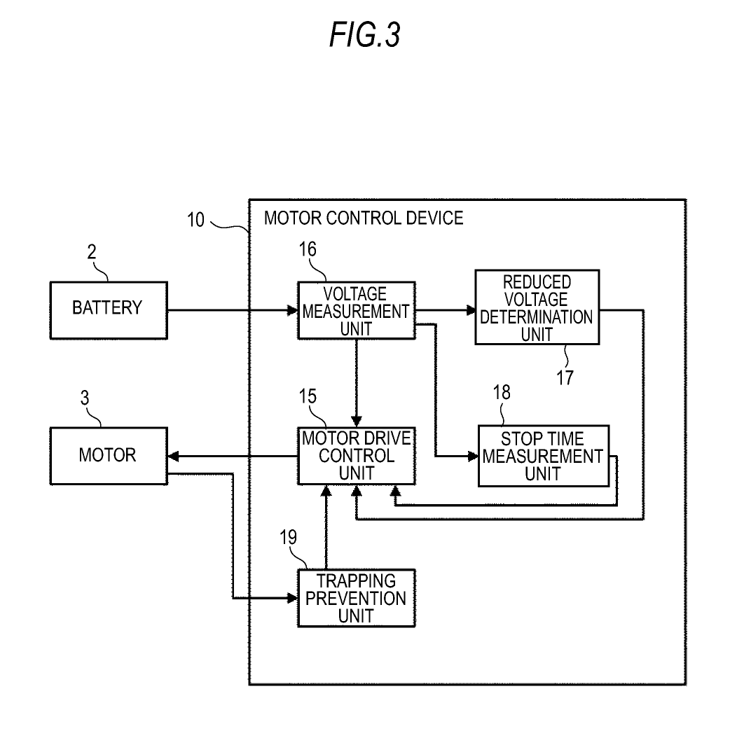

FIG. 3 is a functional block diagram showing functions of the motor control device 10. The motor control device 10 has a motor drive control unit 15 that controls the driving of the motor 3, a voltage measurement unit 16 that measures the voltage of the battery 2, and a trapping prevention unit 19 that measures the number of revolutions of the motor 3 and prevents trapping, based on the number of revolutions. The voltage measurement unit 16 is connected to a reduced voltage determination unit 17 that counts the number of times a reduced voltage is reached, and a stop time measurement unit 18 that measures the time from when the motor 3 is temporarily stopped.

The motor drive control unit 15 starts driving the motor 3 if a predetermined start condition is satisfied. As the start condition, for example, pressing of a button by the user, insertion of the key of the automobile or the like may be used. The motor drive control unit 15 also ends the driving of the motor 3 if a predetermined end condition is satisfied. The end condition refers to a circumstance where equipment reaches a target state due to the driving of the motor 3, for example, where the angle of the seat back and the position of the seat bottom of the seat 4 reach a desired state. Whether the desired state is reached or not can be determined, for example, by acquiring the cumulative number of revolutions of the motor 3 and determining whether a cumulative number of revolutions that is necessary to reach the desired state is achieved or not. The desired state is stored in advance in the non-volatile storage device 14 and read out by the motor drive control unit 15 when necessary or before that.

That is, when a start signal to start driving the motor 3 is inputted, the motor drive control unit 15 outputs a control signal to drive the motor 3 to the motor 3 and thus starts driving the motor 3. In this embodiment, the equipment that is drive-controlled by the motor 3 is the seat 4. For example, in an example where pressing of a button causes the seat 4 to move to a desired position that is stored, when the user presses the button, a circuit (not shown) that is interlocked with the button and outputs a start signal, outputs the start signal to the motor drive control unit 15. The motor drive control unit 15, receiving the start signal from the circuit, sends a control signal to the motor 3 to start driving.

According to the type of the start condition and the end condition, the motor drive control unit 15 has an arbitrary monitoring function (not shown) that is necessary to detect the start condition and the end condition. The monitoring function may be, for example, a button press detection function or a number of motor revolutions measurement function.

The voltage measurement unit 16 measures the voltage of the battery 2. The voltage measurement unit 16 stores the measured voltage into the volatile storage device 13 or the non-volatile storage device 14. The motor drive control unit 15 reads out the stored voltage and carries out a determination about the voltage. That is, the motor drive control unit 15 temporarily stops the driving of the motor 3 if the voltage measured by the voltage measurement unit 16 is below a predetermined stop voltage (referred to as a reduced voltage state). Thus, the risk that the voltage of the battery 2 may fall below the guarantee voltage of the CPU and memory due to a voltage fall, thus causing occurrence of an abnormality in the control data, can be reduced. The stop voltage is an arbitrary voltage that is higher than the guarantee voltage. It is desirable that the stop voltage is set away from the guarantee voltage so that the motor 3 can be securely stopped before the battery voltage falls below the guarantee voltage because of a voltage fall. The stop voltage is stored in advance in the non-volatile storage device 14 and read out by the motor drive control unit 15 when necessary or before that.

Moreover, the motor drive control unit 15 resumes the driving of the motor 3 if the voltage measured by the voltage measurement unit 16 becomes higher than a predetermined recovery voltage after the driving of the motor 3 is temporarily stopped. The recovery voltage is an arbitrary voltage higher than the stop voltage. It is desirable that the recovery voltage is set away from the stop voltage so that stop and recovery will not be repeated due to small fluctuations in the battery voltage. The recovery voltage is stored in advance in the non-volatile storage device 14 and read out by the motor drive control unit 15 when necessary or before that.

When the voltage of the battery 2 falls below the predetermined stop voltage and the driving of the motor 3 is temporarily stopped, it is desirable that the control data (for example, the number of revolutions) of the motor 3 stored as temporary data on the volatile storage device 13 is stored on the non-volatile storage device 14. Thus, even if the battery voltage falls below the guarantee voltage due to a voltage fall, occurrence of an abnormality in the control data can be prevented. After that, when the voltage of the battery 2 exceeds the predetermined recovery voltage and the driving of the motor 3 is resumed, the control data stored on the non-volatile storage device 14 can be read out again onto the volatile storage device 13 so that the driving of the motor 3 can be continued from the middle of the process.

The reduced voltage determination unit 17 counts the number of times the battery 2 falls into the reduced voltage state during one continuous operation (referred to as a reduced voltage count). The one continuous operation is the driving of the motor 3 for a period after the motor drive control unit 15 detects one start condition (for example, pressing of a button) and starts controlling the motor 3, until the control of the motor 3 is ended. It is assumed that the one continuous operation continues even if the driving of the motor 3 is temporarily stopped due to detection of the reduced voltage state and later resumed.

The reduced voltage determination unit 17 stores the reduced voltage count in the volatile storage device 13 or the non-volatile storage device 14. The motor drive control unit 15 reads out the stored reduced voltage count and determines the reduced voltage count. That is, if the reduced voltage count reaches a predetermined reference value, the motor drive control unit 15 ends the control of the motor 3. Thus, when the driving of the motor 3 in the reduced voltage state is resumed, occurrence of a voltage fall immediately after the resumption of the driving of the motor 3, causing the driving of the motor 3 to stop again, and consequent repetition of resumption and stop can be prevented. Moreover, continuous trapping of a part of a human body in the equipment driven by the motor 3 can be prevented.

The reference value for the reduced voltage count to end the control of the motor 3 can be set to an arbitrary number that is at least two or greater. For example, if the reduced voltage state is allowed to occur once due to cranking and once due to temporary trapping, the reference value for the reduced voltage count may be three. The reference value for the reduced voltage count is stored in advance in the non-volatile storage device 14 and read out by the motor drive control unit 15 when necessary or before that.

The stop time measurement unit 18 measures the time during which the driving of the motor 3 is temporarily stopped because the battery 2 is in the reduced voltage state. The stop time measurement unit 18 stores the temporary stop time in the volatile storage device 13 or the non-volatile storage device 14. The motor drive control unit 15 reads out the stored time and determines the time. That is, the motor drive control unit 15 ends the control of the motor 3 if the temporary stop time is equal to or longer than a predetermined value. Thus, the motor 3 can be prevented from remaining in the temporarily stopped state for a long period as the voltage of the battery 2 fails to recover to the recovery voltage. The reference time for the temporary stop time is stored in advance in the non-volatile storage device 14 and read out by the motor drive control unit 15 when necessary or before that.

The trapping prevention unit 19 acquires the number of revolutions per unit time of the motor 3 (also referred to simply as the number of revolutions). The number of revolutions per unit time of the motor 3 represents the speed of the motor 3. If the number of revolutions of the motor 3 suddenly falls during the driving of the motor 3, it can be assumed that there is an occurrence of trapping in the equipment driven by the motor 3. The trapping prevention unit 19 stores the acquired number of revolutions in the volatile storage device 13 or the non-volatile storage device 14. The motor drive control unit 15 reads out the stored number of revolutions and determines the number of revolutions. That is, if the number of revolutions of the motor 3 falls to or below a predetermined value, the motor drive control unit 15 stops the driving of the motor 3, assuming that there is an occurrence of trapping.

The number of revolutions to be a reference for stop can be decided through an experiment, simulation or the like. The reference value for the number of revolutions is stored in advance in the non-volatile storage device 14 and read out by the motor drive control unit 15 when necessary or before that.

In this embodiment, the driving of the motor 3 is stopped if the number of revolutions falls to or below a predetermined value. However, the driving of the motor 3 may be reversed (rotated backward). Thus, when a part of a human body is trapped in the equipment driven by the motor 3, the human body part can be easily released.

In this embodiment, it is assumed that there is an occurrence of trapping if the number of revolutions falls to or below a predetermined value. However, arbitrary means that can detect or estimate the occurrence of trapping, such as a contact sensor, may be used.

In this embodiment, each of the motor drive control unit 15, the voltage measurement unit 16, the reduced voltage measurement unit 17, the stop time measurement unit 18 and the trapping prevention unit 19 is stored as a program in the non-volatile storage device 14. A part or the whole of these functions may be installed as an electric circuit instead of a program.

FIG. 4 is a flowchart showing a program to carry out drive control of the motor using the motor control device 10. As a start signal generated by the user pressing a button or the like is inputted to the motor control device 10, the motor control device 10 reads out the program shown in FIG. 4 from the non-volatile storage device 14 and starts drive control of the motor according to this embodiment. First, the motor drive control unit 15 starts driving the motor 3 and starts controlling the motor 3 (step S11). At the same time, if the stop time measurement unit 18 measures the time during which the motor 3 is temporarily stopped, the stop time measurement unit 18 stops the measurement and resets the time.

Although not shown in the flowchart of FIG. 4, the trapping prevention unit 19 monitors the number of revolutions of the motor 3 during the driving of the motor 3. If the motor drive control unit 15 determines that the number of revolutions of the motor 3 measured by the trapping prevention unit 19 is equal to or lower than a predetermined value, the motor drive control unit 15 stops the driving of the motor 3 irrespective of the processing shown in FIG. 4.

After the driving of the motor 3 is started, the motor drive control unit 15 determines whether a predetermined end condition is reached or not (step S12). If the motor drive control unit 15 determines that the predetermined end condition is reached, the motor drive control unit 15 stops the driving of the motor 3 and ends the control of the motor 3 (step S13).

If the motor drive control unit 15 determines that the end condition is not reached, the motor drive control unit 15 determines whether or not the voltage of the battery 2 measured by the voltage measurement unit 16 is equal to or lower than the stop voltage (step S14). If the motor drive control unit 15 determines that the voltage of the battery 2 is equal to or lower than the stop voltage (the reduced voltage state takes place), the motor drive control unit 15 temporarily stops the driving of the motor 3 (step S15). At the same time as the temporary stop of the driving of the motor 3, the stop time measurement unit 18 starts measuring the time during which the driving of the motor 3 is temporarily stopped.

If the end condition is not reached and the voltage of the battery 2 is higher than the stop voltage, the driving of the motor 3, the monitoring (determination) of the end condition, and the monitoring (determination) of the voltage of the battery 2 are continued.

As the driving of the motor 3 is temporarily stopped in step S15, the reduced voltage determination unit 17 adds 1 to the reduced voltage count (step S16). Here, the reduced voltage count represents the number of times the battery 2 falls into the reduced voltage state. In the initial state, the reduced voltage count is 0. The motor drive control unit 15 determines whether the reduced voltage count reaches a predetermined value or not (step S17). If the motor drive control unit 15 determines that the reduced voltage count reaches the predetermined value, the motor drive control unit 15 completely stops the motor 3, which is temporarily stopped, and ends the control of the motor 3 (step S13).

If the motor drive control unit 15 determines that the reduced voltage count is smaller than the predetermined value, the motor drive control unit 15 determines whether or not the voltage of the battery 2 is equal to or lower than the recovery voltage (step S18). If the motor drive control unit 15 determines that the voltage of the battery 2 is higher than the recovery voltage, the motor drive control unit 15 resumes the driving of the motor 3 (step S11). After that, the driving of the motor 3, the monitoring (determination) of the end condition, and the monitoring (determination) of the voltage of the battery 2 are continued.

If the motor drive control unit 15 determines that the voltage of the battery 2 is equal to or lower than the recovery voltage, the motor drive control unit 15 determines whether a predetermined time has passed since the temporary stop of the driving of the motor 3 or not (step S19). If the motor drive control unit 15 determines that the predetermined time has passed since temporary stop of the driving of the motor 3 in step S15, the motor drive control unit 15 completely stops the motor 3, which is temporarily stopped, and ends the control of the motor 3 (step S13).

If the voltage of the battery 2 is equal to or lower than the recovery voltage and the predetermined time has not passed yet since the temporary stop of the driving of the motor 3 in step S15, the temporary stop of the driving of the motor 3 and the monitoring (determination) of the voltage of the battery 2 are continued.

According to the driving control program for the motor shown in FIG. 4, the driving of the motor 3 is resumed if a voltage fall is temporary during one continuous operation, whereas the driving of the motor 3 is not resumed if the number of times the battery 2 falls into the reduced voltage state reaches a predetermined number of times. Therefore, convenience for the user is improved by the automatic resumption of the driving of the motor 3, and when a continuous voltage fall occurs, resumption and stop of the driving of the motor 3 are not repeated for long and the motor 3 can be stopped securely. If the cause of the continuous voltage fall is trapping, the trapping can be prevented from continuing for a long period. Also, since the driving of the motor 3 is not resumed if a predetermined time has passed since the temporary stop, repletion of resumption and stop of the driving of the motor 3 and continuation of the trapping for a long period can be prevented more securely. Moreover, since the voltage is used for determination, no additional sensor needs to be provided and the device can be installed at a low cost.

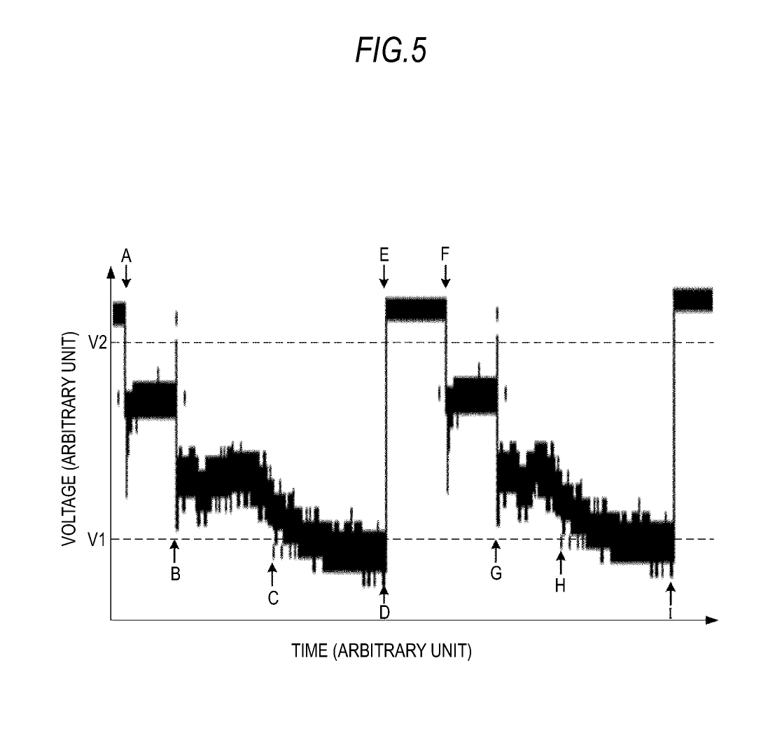

FIG. 5 is a graph showing illustrative voltage change in the case where drive control of the motor is carried out using the motor control device 10. The horizontal axis of FIG. 5 represents the time elapsed. The vertical axis represents the voltage of the battery 2 acquired by the voltage measurement unit 16. V1 indicates the stop voltage. V2 indicates the recovery voltage.

First, at A in FIG. 5, the motor drive control unit 15 starts driving the motor 3 (step S11). After that, at B in FIG. 5, for example, trapping occurs and a large voltage falls takes place. Consequently, the voltage falls to or below the stop voltage V1 before the trapping prevention function is actuated.

At C in FIG. 5, the motor drive control unit 15 determines that the voltage is equal to or below the stop voltage V1 (step S14). After that, at D in FIG. 5, the motor drive control unit 15 temporarily stops the driving of the motor 3 (step S15) and the reduced voltage determination unit 17 adds the reduced voltage count (step S16).

As the driving of the motor 3 is temporarily stopped, the lowered voltage rises. At E in FIG. 5, the motor drive control unit 15 determines that the voltage of the battery 2 is higher than the recovery voltage V2 (step S18). After that, at F in FIG. 5, the motor drive control unit 15 resumes the driving of the motor 3 (step S11).

If the trapping continues after the resumption of the driving of the motor 3, a voltage fall occurs again, as shown at G in FIG. 5. At H in FIG. 5, the motor drive control unit 15 determines that the voltage is equal to or below the stop voltage V1 again because of the voltage fall (step S14). After that, at I in FIG. 5, the motor drive control unit 15 temporarily stops the driving of the motor 3 (step S15) and the reduced voltage determination unit 17 adds the reduced voltage count (step S16). At this point, the reduced voltage count is 2. Here, since the reference number of times for the reduced voltage count is set at 2, the motor drive control unit 15 determines that the reduced voltage count has reached the reference number of times (step S17) and ends the control of the motor 3 (step S13).

If the trapping prevention function is actuated before the voltage falls to or below the stop voltage V1, the voltage fall is eliminated and therefore there is no problem of continuous trapping. Here, since the voltage falls to or bellow the stop voltage V1 before the trapping prevention function is actuated (due to deterioration of the battery or the like), stop and resumption of motor driving will be repeated forever in the traditional method. However, if the motor control device according to the embodiment disclosed here is used, even if the voltage falls to or below the stop voltage V1 before the trapping prevention function is actuated, resumption of motor driving is stopped at a predetermined number of times and therefore continuation of the trapping can be prevented.

The technique disclosed here is not limited to the above embodiment and can be modified suitably without departing from the scope of the disclosure.

### Other Embodiments

A processing method in which a program that operates the configuration of the foregoing embodiment so as to realize the functions of the embodiment (for example, a program to execute the processing shown in FIG. 4) is stored in a storage medium and in which the program stored in the storage medium is read out as a code and executed on a computer, is also included in the scope of the foregoing embodiment. That is, a computer-readable storage medium is also included in an example of embodiment. Also, a storage medium in which the computer program is stored and the computer program itself are included in the foregoing embodiment.

Such a storage medium can be, for example, a Floppy (trademark registered) disk, hard disk, optical disk, magneto-optical disk, CD-ROM, magnetic tape, non-volatile memory card, or ROM.

Also, not only the program that is stored in the above storage medium and executes processing by itself, but also a program that operates on an OS in cooperation with the functions of other software and extended board and thus executes the operations of the embodiment is included in the scope of the embodiment.

What is claimed is:

1. A motor control device for controlling a motor that drives by receiving electric power supply from a power source, the device comprising:
a voltage measurement unit that measures a voltage of the power source;
a reduced voltage determination unit that counts a number of times the voltage becomes equal to or lower than a predetermined stop voltage; and
a motor drive control unit that controls driving of the motor;
wherein the motor drive control unit stops the driving of the motor if the voltage is equal to or lower than the predetermined stop voltage while the motor is driving, and
the motor drive control unit resumes the driving of the motor if the number of times counted by the reduced voltage determination unit is smaller than a predetermined number of times and the voltage is higher than a predetermined recovery voltage while the motor is stopped.

2. The motor control device according to claim 1, further comprising a trapping prevention unit that detects trapping generated by the driving of the motor and stops or reverses the driving of the motor.

3. The motor control device according to claim 1, further comprising a stop time measurement unit that measures a time during which the motor is stopped,
wherein the motor drive control unit resumes the driving of the motor if the number of times counted by the reduced voltage determination unit is smaller than a predetermined number of times, the voltage is higher than a predetermined recovery voltage, and the time measured by the stop time measurement unit does not pass a predetermined time, while the motor is stopped.

4. The motor control device according to claim 1, wherein the motor is a motor that drives one or two or more pieces of automobile equipment selected from a group made up of a sheet, a window, a sunroof, a sliding door, a rear door, and a trunk lid.

5. The motor control device according to claim 1, wherein the predetermined recovery voltage is higher than the predetermined stop voltage.

6. The motor control device according to claim 1, wherein the predetermined number of times is two or greater.

7. A motor control program for controlling a motor that drives by receiving electric power supply from a power source, the program causing a computer to execute the steps of:
measuring a voltage of the power source;
counting a number of times the voltage becomes equal to or lower than a predetermined stop voltage;
stopping driving of the motor if the voltage is equal to or lower than the predetermined stop voltage while the motor is driving; and
resuming the driving of the motor if the number of times counted is smaller than a predetermined number of times and the voltage is higher than a predetermined recovery voltage while the motor is stopped.

8. The motor control program according to claim 7, further causing the computer to execute the step of detecting trapping generated by the driving of the motor and stopping or reversing the driving of the motor.

9. The motor control program according to claim 7, further causing the computer to execute the step of measuring a time during which the motor is stopped,
wherein in the step of resuming the driving of the motor, the driving of the motor is resumed if the number of times counted is smaller than a predetermined number of times, the voltage is higher than a predetermined recovery voltage, and the measured time does not pass a predetermined time, while the motor is stopped.

10. The motor control program according to claim 7, wherein the motor is a motor that drives one or two or more pieces of automobile equipment selected from a group made up of a sheet, a window, a sunroof, a sliding door, a rear door, and a trunk lid.

11. The motor control program according to claim 7, wherein the predetermined recovery voltage is higher than the predetermined stop voltage.

12. The motor control program according to claim 7, wherein the predetermined number of times is two or greater.

13. A computer-readable storage medium in which the motor control program according to claim 7 is stored.

14. A motor control method for controlling a motor that drives by receiving electric power supply from a power source, the method comprising the steps of:
measuring a voltage of the power source;
counting a number of times the voltage becomes equal to or lower than a predetermined stop voltage;
stopping driving of the motor if the voltage is equal to or lower than the predetermined stop voltage while the motor is driving; and
resuming the driving of the motor if the number of times counted is smaller than a predetermined number of times and the voltage is higher than a predetermined recovery voltage while the motor is stopped.

15. The motor control method according to claim 14, further comprising the step of detecting trapping generated by the driving of the motor and stopping or reversing the driving of the motor.

16. The motor control method according to claim 14, further comprising the step of measuring a time during which the motor is stopped,
wherein in the step of resuming the driving of the motor, the driving of the motor is resumed if the number of times counted is smaller than a predetermined number of times, the voltage is higher than a predetermined recovery voltage, and the measured time does not pass a predetermined time, while the motor is stopped.

17. The motor control method according to claim 14, wherein the motor is a motor that drives one or two or more pieces of automobile equipment selected from a group made up of a sheet, a window, a sunroof, a sliding door, a rear door, and a trunk lid.

18. The motor control method according to claim 14, wherein the predetermined recovery voltage is higher than the predetermined stop voltage.

19. The motor control method according to claim 14, wherein the predetermined number of times is two or greater.
